(19) United States
(12) Patent Application Publication
(10) Pub. No.: US 2015/0110190 A1
(43) Pub. Date: Apr. 23, 2015

(54) METHOD AND APPARATUS FOR MOTION ESTIMATION

(71) Applicant: Sony Corporation, Minato-ku (JP)

(72) Inventors: Piergiorgio SARTOR, Fellbach (DE); Thimo Emmerich, Wendlingen (DE); Christian Unruh, Stuttgart (DE); Francesco Michielin, Stuttgart (DE)

(73) Assignee: Sony Corporation, Minato-ku (JP)

(21) Appl. No.: 14/505,626

(22) Filed: Oct. 3, 2014

(30) Foreign Application Priority Data
Oct. 21, 2013 (EP) 13189512.0

(51) Int. Cl. H04N 19/583; H04N 19/527; H04N 19/51

(52) U.S. Cl. CPC H04N 19/00733; H04N 19/00696; H04N 19/00593
USPC 375/240.16

(57) ABSTRACT

In a method for estimating motion vectors for blocks of a current video image in a sequence of video images, each video image being divided into a plurality of blocks, the following is performed:
determining (13) a motion vector for a block of a previous video image;
projecting (16) the determined motion vector of the block of the previous video image to a block position of the current video image, thereby obtaining a projected motion vector; and
performing (18) a motion estimation for a current block of the current video image on the basis of the projected motion vector, thereby obtaining a motion vector for the current block of the current video image.

### FIELD OF THE DISCLOSURE

The present disclosure generally pertains to a method and an apparatus for motion estimation.

### BACKGROUND

Generally, motion estimation determines motion vectors that describe the transformation from one two-dimensional image to another, such as consecutive images of a video stream. A video stream is typically divided into consecutive image frames and the motion estimation determines motion vectors between two consecutive frames. The motion vectors describe the motion, for example, of objects in the image, of pixels, of blocks or of the whole image. The motion estimation of motion vectors describing the motion of the whole image is also referred to as global motion estimation.

The motion estimation is typically used for consumer display scan rate conversion, where, e.g. a video stream scanned with a lower scan rate is up-rated to a video stream with a higher scan rate. Display frequencies are, e.g. 60 Hz, 75 Hz, 100, Hz or even higher for up-to-date displays, while the typical video frequencies are 25 Hz and 50 Hz for PAL film and video material and 24 Hz and 60 Hz for NTSC film and video material, such that an up-conversion of such films and video materials are needed for displaying it on displays with higher frequencies.

For image-rate up-conversion it is known that a good quality is achieved when the objects in the images are interpolated along their motion trajectory. This results in a smooth motion of the objects in a scene represented in the images, as, for example, opposed to jerky motion or judder created by a pure picture repetition. Hence, for a good quality up-conversion it is useful that the estimated motion vector field has a high correlation with the “true” motion of the objects in the scene.

Moreover, motion vector estimation can be used in predictive video encoding applications, e.g. MPEG4 and H.264.

A variety of true-motion estimation algorithms is known, e.g. Bayesian motion estimation or Phase Plane correlation. Moreover, a well known true-motion estimation algorithm is the so-called 3-D Recursive Search (3DRS).

From Marijn J. J. Loomans, Cornlis J. Koeleman, Peter H. N. de With, “Highly-Parallelized Motion Estimation for Scalable Video Coding”, downloadable from http://dLacm.org/citation.cfm?id=1818719.1819164, a highly-parallel motion estimator for real-time Scalable Video Coding (SVC) is known. According to this highly parallel predictive search (HPPS) two vector candidates are used, one derived from the spatial neighborhood of motion vectors and one derived from the temporal neighborhood. The temporal neighborhood can be predetermined, allowing fetching of image data for the temporal vector candidate, while the spatial neighborhood is calculated, or vice-versa, which enables continuous parallel data fetching and Sum of Absolute Differences (SAD) calculations.

A block parallel fast motion estimation for blocks of a video frame is known from US 2009/0268821 A1. The encoding of video blocks can be ordered to allow concurrent encoding thereof. Motion vector prediction can be performed concurrently for independent video blocks where requisite blocks for calculating the prediction of a given block can be previously encoded, but not all blocks depend from each other. Thus, parallel motion vector estimation is possible.

From Yi Gao, Jun Zhou, “Motion vector extrapolation for parallel motion estimation on GPU”, Multimedia Tools and Applications, March 2012, DOI 10.1007/s11042-012-1074-4, a motion vector extrapolation based approach (MVEA) for enhancing rate-distortion performance of parallel motion estimation on a Graphics Processing Unit (GPU) is known, which is based on the study of motion vector recovery strategies for frame loss error concealment.

It is an object to provide an improved method and apparatus for estimating motion vectors, and an electronic device having such an apparatus.

### SUMMARY

According to a first aspect a method for estimating motion vectors for blocks of a current video image in a sequence of video images is provided, each video image being divided into a plurality of blocks, the method comprising: determining a motion vector for a block of a previous video image; projecting the determined motion vector of the block of the previous video image to a block position of the current video image, thereby obtaining a projected motion vector; and performing a motion estimation for a current block of the current video image on the basis of the projected motion vector, thereby obtaining a motion vector for the current block of the current video image.

According to a second aspect an apparatus for estimating motion vectors for blocks of a current video image in a sequence of video images is provided, each video image being divided into a plurality of blocks, the apparatus comprising: a block matcher configured to estimate motion vectors for blocks of the video images; and a vector projector configured to project determined motion vectors of blocks of a previous video image to block positions of the current video image, thereby obtaining projected motion vectors; wherein the block matcher is further configured to perform a motion estimation for a current block of the current video image on the basis of at least one projected motion vector, thereby obtaining a motion vector for the current block of the current video image.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 illustrates a 3D recursive search for motion estimation;

FIG. 2a illustrates a previous video image with estimated motion vectors;

FIG. 2b illustrates a current video image with projected motion vectors;

FIG. 3 illustrates an embodiment of a method for motion estimation;

FIG. 4 illustrates an embodiment of a motion estimator; and

FIG. 5 illustrates an embodiment of an electronic device including a motion estimator.

### DETAILED DESCRIPTION OF EMBODIMENTS

Before a detailed description of embodiments under reference to FIGS. 2a to 5, general explanations are made.

The objective of block-based motion estimation algorithms used for predictive coding is to find for each block of pixels of an image the displacement vector that minimizes the difference between the block of pixels of a reference frame and the block of pixels displaced by this vector of a predicted frame. To find displacement vectors a full-search strategy or other strategies, such as Bayesian motion estimation, Phase Plane correlation, 3-D Recursive Search (3DRS), or the like can be used.

The calculated differences, i.e. errors, between the block of pixels of a reference frame and the block of pixels displaced by this displacement vector of a predicted frame is usually the Sum of Absolute Differences (SAD) which is to be minimized, in order to find a true motion vector.

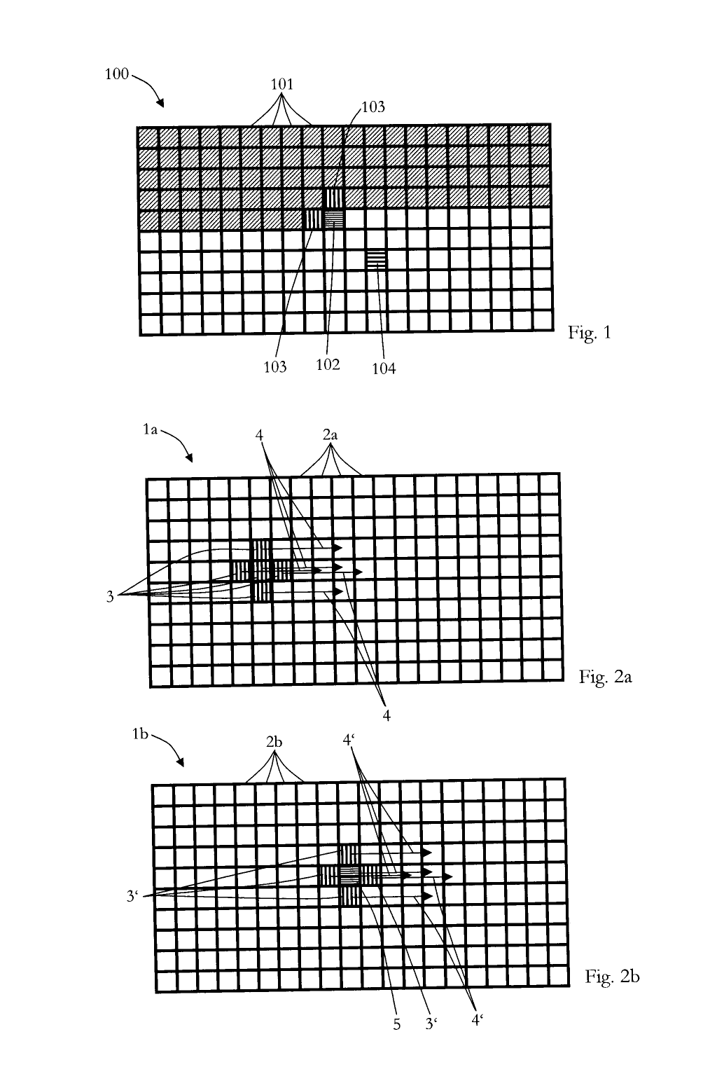

Known true motion vector estimators, such as the well-known 3-D Recursive Search (3DRS) mentioned at the outset, use a recursive approach in order to satisfy the requirement of low complexity, good quality motion vectors. Typically, the 3DRS algorithm constructs a small set of candidate vectors based on spatial and temporal predictions which are used as a reduced set of displacement vectors for the SAD calculation. Instead of testing all motion vectors in a certain search range, 3DRS basically limits the number of vectors to those already estimated in the image. This is illustrated in in FIG. 1.

FIG. 1 illustrates a current image frame 100, which is divided into multiple blocks, each block consisting of a predefined number of pixels, e.g. 8×8. Blocks 101, for which already a motion vector has been calculated are illustrated with a fine diagonal hatching (which is from lower left to upper right). In FIG. 1 reference numeral 101 only points to four blocks 101. However, all blocks with the same hatching as blocks 101 are blocks for which a motion vector has already been calculated for the current image frame 100. A current block 102, for which a motion vector is to be estimated is illustrated with a fine horizontal hatching and it is in the middle of image frame 100 of FIG. 1 in this present example.

For each current block 102 the 3DRS algorithm uses spatial vector candidates from adjacent blocks 103 for which already in the current image frame 100 motion vectors have been estimated. Such blocks 103 are illustrated with a vertical hatching in FIG. 1. In the present example of FIG. 1, the scan direction for motion estimation performed by the 3DRS algorithm is line-wise from upper left to lower right. This means that for current block 102 spatial vector candidates are only available for an adjacent block 103 on the left and an adjacent block 103 above current block 102. The blocks on the right side of current block 102 and below have not yet been estimated for the current image frame 100 and, thus, for these blocks no vector candidate estimated for the current image frame 100 is available.

Other prediction vectors are available from the estimation of blocks of a previous image frame, such as illustrated in FIG. 1 for block 104, which is illustrated with a coarse horizontal hatching and which is distant from current block 102. Such temporal predictors which are based on motion vectors estimated for a block of a previous image frame are also referred to as temporal (vector) candidates or temporal prediction vectors. The temporal candidates have typically a fixed offset with respect to the current block 102, such as two blocks downwards and two blocks to the right, as it is the case for block 104 of the temporal candidate. In addition to spatial and temporal candidates so-called update candidates are added to the candidate set, which provide a fast convergence of the 3DRS algorithm. Update candidates are generated by adding small random vectors to spatial candidates of the current image frame 100. Update candidates address e.g. the problem that objects do not always linearly move.

In this example, the two spatial candidates, the temporal candidate, and e.g. two update candidates are used as a candidate set for determining a displacement vector for the current block, for which the motion vector is to be estimated. In contrast, for example, to a full search algorithm according to which all displacements vectors are calculated, the computation effort is reduced to five candidates.

These concepts of motion estimation and in particular the concept of spatial candidates, temporal candidates and update candidates as well as motion estimation algorithms relying on these concepts are well known to the skilled person.

However, recursive search algorithms, such as 3DRS discussed above, rely on vectors previously estimated for a current image in order to produce new ones. While this approach has several computational advantages, as discussed, it is not suitable in all embodiments for implementation on parallel hardware, like graphic cards using a Graphics Processing Unit (GPU), which is specialized in performing parallel tasks. The reason is that in order to evaluate candidate vectors at a certain position, vectors already estimated at previous positions, such as for blocks 101 in FIG. 1, must be known, as discussed above.

Thus, for recursive search algorithms it could be difficult to parallelize the operations, since they are naturally cascaded, i.e. the motion estimation for a current block, such as current block 102 in FIG. 1, needs the motion vectors of blocks previously estimated for the current image, such as neighboring blocks 103 from which the spatial candidates are derived.

Thus, it has been recognized that the difficulty in parallelizing the block motion estimation, e.g. for a GPU, arises from the usage of such “spatial” predictors, i.e. vector candidates estimated at the same time instance as the current estimation.

Accordingly, some embodiments pertain to a method for determining a motion vector for a block of a current video image in a sequence of video images.

As mentioned above, video images are also referred to as frames. Generally, two main scan methods for producing video images exist, namely interlace and progressive scan. In interlace scan, the image is divided into two half-images, while in progressive scan each frame comprises the total image. The present embodiments are not limited to specific frames and they generally pertain to video images produced with interlace and progressive scan or other methods.

Each video image is divided into a plurality of blocks. A block is defined by a predetermined amount of video image pixels. The blocks may have any shape, e.g. quadratic, rectangular, circular, diamond, etc., and the block may have any size. Blocks typically have a size of 8×8 pixels, but also other sizes are common, such as 4×4, 16×16, 32×32 or rectangular sizes, e.g. 4×8, 8×16, or the like. The embodiments are not limited to specific block sizes.

A motion vector for a block of a previous video image is determined. As mentioned, the video sequence includes multiple video images which are arranged one after another in time (successively). A previous video image is, thus, an “earlier” image compared to the current video image. In some embodiments, the previous video image and the current video image are consecutively to each other, such that no other video image is interposed between them. In other embodiments, one or more video images can be interposed between the previous video image and the current video image. For the previous video image for each block a motion vector may have been determined.

The determination can comprise the same procedure as for the current video image, which will be discussed below.

The determined motion vector of the block of the previous video image is projected to a block position of the current video image. Thereby a projected motion vector is obtained. This procedure can be done for all determined motion vectors, which have been estimated for the blocks of the previous video image. In other words, in some embodiments there exists a motion vector field of the blocks of the previous video image which is projected in total to the current video image.

The projection can be done on the basis of the motion vectors of the previous video image. As from the already estimated motion vectors of the previous video image the motion of each block is known, it can be predicted, under the assumption that each block will make the same motion from the previous video image to the current video image, where each block of the previous image has to be found in the current video image.

For instance, for such blocks of the previous image for which no motion vector is found, i.e. where the motion vector equals zero, it is assumed that they will have the same position in the current block. For such blocks of the previous image for which e.g. a motion of two blocks in a horizontal direction from left to right is determined it is assumed that such blocks will be found two blocks to the right in the current video image, etc. Hence, the motion vectors of the blocks of the previous video image can be projected in accordance with the expected motion of the blocks. Thereby, for each block of the previous video image and its associated motion vector a position in the current video image can be found.

Motion estimation for a current block of the current video image is performed on the basis of the projected motion vector. Thereby a motion vector for the current block of the current video image is obtained. As discussed, this can be done for all blocks for the current video image.

The motion estimation is generally known and it can be performed as discussed above. For instance, the differences of the displacement vectors between the block of pixels of a reference frame, i.e. a previous video image, and the block of pixels displaced by this displacement vector of a predicted frame, i.e. a current video image, is usually the Sum of Absolute Differences (SAD) which is to be minimized. Of course, there are other criteria for finding a good match of an estimated motion vector, such as cross correlation function, pixel difference classification, mean absolute difference, mean squared difference, integral projection and the like. Moreover, there are various search algorithms which can be implemented in the motion estimation of the embodiments, such as three step search, four step search, binary search, etc. Additionally, it is also known the motion estimation includes disparity estimation.

As the motion vectors of the previous video image are all known at the point of time where the motion vectors of the current video image are estimated, the motion estimation of the blocks of the current video image can be parallelized and can be done simultaneously, e.g. in contrast to the above discussed recursive search, e.g. 3DRS. Hence, the method can be performed, for instance, by a Graphics Processing Unit (GPU), which is typically formed by highly specialized circuits for performing parallel computations of data, such as image data.

Hence, instead of using spatial predictors estimated in the current video image, as it is done by 3DRS discussed above, the projected motion vectors known from the previous video image are taken as predictors for motion estimation of blocks of the current video image in some embodiments. Hence, in some embodiments no motion vectors of the current video image, such as spatial predictors, are used for the motion estimation.

In some embodiments, the known 3DRS is implemented by using the projected motion vectors known from the previous image instead of the spatial predictors of the current video image. Thereby, the advantages of 3DRS can be obtained in some embodiments, while simultaneously the disadvantage that the spatial vectors of the current video image are used as predictors, which makes parallelization difficult, is overcome.

In some embodiments the motion estimation is performed on the basis of at least one of: projected motion vector at the block position of the current block and projected motion vector at a block position being adjacent and/or directly adjacent to the current block. In the case of a block position which is directly adjacent to the current block no further block is located between the block position and the current block, while in the case of a block position which is adjacent to the current block, one ore blocks can be located between the block position and the current block. It can be assumed that the motion of blocks at the same position of the current block, for which the motion is to be estimated, and of neighboring blocks (adjacent and/or directly adjacent blocks) of the current block is similar or even identical, since it is assumed that objects in an image are typically larger than the block size. In some embodiments the number of projected motion vectors which are used for motion estimation of the current block depends on the kind of video images, the content, performance requirements, the system, such as the CPU or GPU on which the method is executed, etc.

For instance, a cross-shaped configuration of the projected motion vectors as predictors can be used for motion estimation. This means, one projection motion vector is related to the block at the position of the current block, for which the motion estimation is to be done, one is directly on the left side of the current block, one directly on the right side, one directly above and one directly below. Of course, also other configurations can be implemented. For instance, the projected motion vector at the position of the current block as well as eight surrounding motion vectors can be used as predictors. It can also be a horizontal line configuration of three projection motion vectors used, i.e. one at the position of the current block, one on the left side and one on the right side. It can also be a vertical line configuration of three projection motion vectors used, i.e. one at the position of the current block, one on the upper side and one on the lower side, etc. In some embodiments, configurations can be used where not all or even no projected motion vector is at a position which is directly adjacent to the current block, but one or more projected motion vectors is/are at a position where one or more blocks are located between the projected motion vector position and the current block.

The skilled person will appreciate that the number and the positions of projected motion vectors can be chosen in dependence of a specific task to be fulfilled and in dependence on the constraints exemplary mentioned above, such as performance, image size, block size, etc.

Such a configuration of projected motion vectors which is used for motion estimation is also referred to as set of candidates or set of candidate vectors which includes the predictors, i.e. already estimated motion vectors in the neighborhood of the current block. As discussed, in 3DRS such a candidate set of candidate vectors can include five candidates, such as two spatial candidates, two update candidates and a temporal candidate. In some embodiments, the motion estimation is performed on the basis of a set of candidate vectors, as discussed, including at least one projected motion vector at the block position of the current block and at least one projected motion vector at a block position being adjacent and/or directly adjacent to the current block. Hence, the candidate set as used in 3DRS is modified by only including projected motion vectors and not spatial candidates from the current video image. In some embodiments, the candidate set does not include spatial candidates from the current video image. However, in some embodiments, the candidate set can additionally include other candidates which are known, when the motion estimation of the current block is estimated, as also discussed below.

In some embodiments additionally global motion estimation for estimating a global motion vector of the current video image can be performed. The global motion estimation can be based on a global motion model, which is generally known to the skilled person. The global motion estimation can use, for example, motion vectors which are already known from the previous video image. A global motion model can parameterize, for instance, typical motions which can occur in video imaging. Generally, two types of motions in video images exist, namely motions of objects and motions caused by camera movements. While camera movements, such as pan, tilt or travel, typically cause a uniform motion vector for the whole image, object movements cause typically a correlation of motion vectors in the spatial domain. As it is known, these two types of movements can be parameterized and a global motion vector can be estimated on the basis of such a global motion model. Exemplary, it is also mentioned that more complex global motion models are known, which parameterize, for instance, the rotation of an object or the like. However, as mentioned, global motion models as such and the global motion estimation as such is known, and, thus, is not needed to be described in detail.

A global motion vector estimated on the basis of a global motion model can be added to the candidate set for the motion estimation. In some embodiments, the global motion vector is used in addition to the projected motion vectors. As discussed above, the motion vectors estimated for the previous video image are projected to the current video image. Generally, it can happen that for blocks in a current video image no motion vector is available, since, for instance, such blocks occur in the current video image for the first time. For instance, a block of the previous video image has occluded an object and by moving the block a certain distance, the object represented by the previously occluded becomes visibly in the current video image. Hence, for such blocks which occur the first time in the current video image, no projected motion vector might be available. In such cases, the estimated global motion vector can be used to fill such gaps, for instance, by using the global motion vector at block positions in the current video image where no projected motion vector is available.

In other cases more than one projected motion vector can occur at a block position in the current video image. This happens, for instance, in cases where two motion vectors of two blocks of the previous image are projected to the same block position in the current video image. In such cases, it is not clear which one of the multiple projected motion vectors is the “correct” one and, e.g. the global motion vector could be used instead as vector predictor.

Alternatively, also a mixed vector can be used as predictor. The mixed vector can be a mean value vector of the two (or more) projected motion vectors which are on the same block position of the current video image.

In some embodiments, the projection of the determined motion vector of the block of the previous video image to a block position of the current video image is performed on the basis of the global motion vector. For example, as from the global motion vector a global motion of the image or objects, i.e. blocks, in the image is known, the motion vectors known from the previous video image can be projected in accordance with the global motion vector to the current video image.

In some embodiments, additionally pre-estimating of an approximate motion vector candidate is performed and the motion estimation for a current block is additionally performed on the basis of the approximate motion vector candidate (also referred to as approximate motion vector or approximate vector hereinafter). As discussed, it can happen that for some blocks in the current video image, no or multiple motion vectors are available. For such cases, the pre-estimated approximated motion vectors can be used, e.g. for blocks where no projected motion vector is available or for such blocks where multiple projected motion vectors are available. Known motion estimation methods can be used for the pre-estimation, as mentioned above. The pre-estimation is performed for the current video image. In order to provide a very fast pre-estimation, the pre-estimating can include reducing the size of the current video image, e.g. by resealing it to a lower pixel resolution. In addition or alternatively, the block size can be enlarged or the search window can be reduced, the number of candidates can be reduced, etc. The idea of the pre-estimation of the current video image is to provide very fast approximated motion vectors, for the reasons mentioned above (no or multiple projected motion vectors available). The concept of pre-estimation is generally known to the skilled person and other techniques than the above-mentioned can be implemented in the embodiments for pre-estimation of motion vectors.

The projected motion vector(s) used for motion estimation can be manipulated on the basis of a random number, e.g. the projected motion vector(s) can be multiplied with a random number (or small random vector) and/or a random number or random offset can be added to the projected motion vector(s). The addition of a random number or random offset to the projected motion vector(s) is performed in some embodiments in particular in cases where the projected motion vector is zero. Thereby a, generally known, update candidate vector is obtained. Generally, the random number can be a true-random number or a pseudo-random number, wherein the pseudo-random number can be dependent from a pre-defined start value for computation of the pseudo-random number. Hence, as it is generally known, the pseudo-random number can be pre-defined in the sense that it is calculated with a deterministic algorithm, also referred to as pseudo-random number generator. The motion estimation is additionally performed on the basis of the update candidate vector, which can be added to the set of candidate vectors. As mentioned previously, the idea of update vectors is in some embodiments to address the issue that objects might not move linearly. It has been shown that the motion estimation converges faster when update candidates are added to the candidate set. The candidate set can include only update vectors in some embodiments or it can include a mixture of update candidates and projected motion vectors (with or without global motion vectors and/or approximate motion vectors).

The skilled person will appreciate that the composition and number of the candidates for motion estimation of the current block(s), i.e. projected motion vectors, global motion vectors, update motion vectors, approximate motion vectors, temporal motion vectors, or the like, can depend on the specific task and/or on given constraints, such as performance, block size, image size, image resolution, image content, and the like.

Of course, the above-discussed method can be repeatedly performed until all blocks of a current video image and until all video images are processed and respective motion vectors are estimated.

Moreover, some embodiments pertain to a computer program comprising program code causing a computer to perform at least partially the method(s) discussed above.

Some embodiments also pertain to a non-transitory computer-readable recording medium that stores therein a computer program product, which, when executed by a processor, causes the method(s) discussed above to be performed at least partially.

Some embodiments pertain to an apparatus for estimating motion vectors for blocks of a current video image in a sequence of video images, each video image being divided into a plurality of blocks. The apparatus is adapted to perform the above discussed method at least partially. Hence, in the following the units of the apparatus are discussed which are configured to perform the above discussed method portions. Generally, the apparatus can be implemented as an electronic circuit (e.g. a motion estimator), integrated circuits, as a processor, e.g. Central Processing Unit or Graphics Processing Unit, as an imaging system including multiple processors, or the like.

The apparatus comprises a block matcher configured to estimate motion vectors for blocks of the video images. The motion estimation has been discussed in very detail above and the block matcher is configured to perform the motion estimation as discussed above (at least partially).

A vector projector is configured to project determined motion vectors of blocks of a previous video image to respective block positions of the current video image, thereby obtaining projected motion vectors, as also discussed above. The projection of the motion vectors of the previous image has been discussed in detail above, and the vector projector is configured to perform the above discussed vector projection at least partially. The block matcher is further configured to perform motion estimation for a current block of the current video image on the basis of at least one projected motion vector, thereby obtaining a motion vector for the current block of the current video image.

The block matcher can further be configured to perform the motion estimation on the basis of at least one of: projected motion vector at the block position of the current block and projected motion vector at a block position being adjacent and/or directly adjacent to the current block, as discussed above.

The block matcher can further be configured to perform the motion estimation on the basis of a set of candidate vectors including at least one projected motion vector at the block position of the current block and at least one projected motion vector at a block position being adjacent and/or directly adjacent to the current block, as discussed above.

The apparatus can further comprise a global motion estimator configured to estimate a global motion vector of the current video image, as discussed above. The global motion estimator can be further configured to estimate the global motion vector on the basis of a global motion model, as discussed.

The vector projector can further be configured to project determined motion vectors of blocks of the previous video image to block positions of the current video image on the basis of the global motion vector, as discussed above.

The apparatus can further comprise a pre-estimator configured to estimate an approximate motion vector candidate. The block matcher can be further configured to perform the motion estimation for a current block additionally on the basis of the approximate motion vector, as discussed above.

The pre-estimator can be further configured to reduce the size of the current video image, e.g. by resealing it with a lower resolution or the like, as discussed above.

The block matcher can be further configured to generate an update candidate vector, as discussed above, by manipulating the projected motion vector on the basis of a random number. The block matcher can be further configured to perform the motion estimation additionally on the basis of the update candidate vector.

The apparatus can further be configured to perform multiple motion estimations for multiple current blocks of the current video image simultaneously. For instance, the apparatus can comprise multiple block matchers for performing multiple block motion estimation computations simultaneously. In addition or alternatively, the apparatus can comprise a processor which is adapted to perform parallel computations, such as a Graphics Processing Unit.

Some embodiments pertain to an electronic device for generating a video image sequence. It comprises a video input for receiving an input video image sequence. The input video image sequence includes multiple consecutive video images, as discussed above. Moreover, it comprises the discussed apparatus for estimating motion vectors, which is adapted to perform the above discussed method at least partially. The apparatus outputs estimated motion vectors for blocks of video images, as discussed above in detail. The electronic device comprises a video image sequence generator configured to generate inter-images on the basis of the estimated motion vectors and to generate an output video image sequence on the basis of the input video image sequence and the inter-images. The inter-images can be based on an interpolation of blocks/objects along their moving trajectory defined by the respective estimated motion vectors, as it is known in the art. An inter-image is inserted between a previous video image and a current video image, e.g. for up-converting the received video image sequence scanned with a scan rate of e.g. 24 Hz to an output video image sequence having a scan rate higher than the input video image sequence (such as 100 Hz, as it is known in the art). The inter-images can also be used for compression of the received video image sequence, as it is known in the art.

The electronic device can be at least one of: Central Processing Unit, Graphics Processing Unit, Personal Computer, laptop, television, display (such as liquid crystal display, thin film transistor display, plasma display panel, organic light emitting diode display, video adapter, graphics adapter, graphics card, or the like.

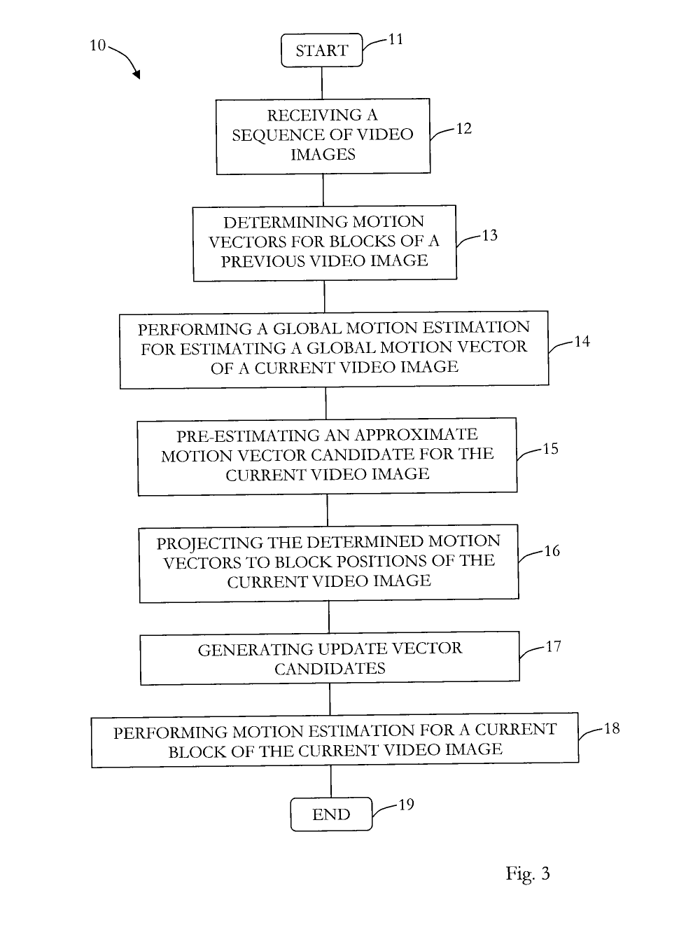

Returning to FIGS. 2a, 2b and 3, an embodiment of a method 10 (FIG. 3), such as discussed above, for estimating motion vectors for blocks of a current video image in a sequence of video images is illustrated. The method 10 starts at 11 and receives the sequence of video images at 12.

FIG. 2a illustrates a previous video image 1a of the sequence of video images, which is divided into blocks 2a (reference numeral 2a only points to some of the blocks for simplicity reasons). Each block has, e.g. 8×8 pixels in it. The video image 1a is divided into 20×10 blocks, i.e. 10 blocks in the vertical direction and 20 blocks in the horizontal direction. The other images of the sequence of video images are divided identically.

FIG. 2b illustrates a current video image 1b which is in the same way divided into blocks 2b as the previous image 1a. The previous image 1a and the current image 1b are consecutively to each other.

At 13, according to method 10, motion vectors for each block 2a of the previous video image 1a are determined, i.e. motion estimated. Exemplary, five blocks 3 with estimated motion vectors 4 are illustrated in FIG. 2a (as mentioned, typically for each block of the previous video image a motion vector is estimated). The five blocks 3 form a cross shape: one block 3 is in the middle, one adjacent on the left, one adjacent on the right, one adjacent above and one adjacent below.

For simplification and illustrative reasons it is assumed in FIGS. 2a and 2b that the estimated motion vectors 4 for the five blocks 3 of the previous video image 1a point all in the same horizontal direction and have the same length, i.e. they indicate a motion of the five blocks 3 of four blocks in the right direction. Of course, this is a simplified example and the present disclosure is not limited to this specific example.

In addition, at 14, a global motion estimation is performed, as discussed above in more detail. From the global motion estimation a global motion vector for the current video image 1b can be derived.

Also a pre-estimation is performed at 15, from which an approximate motion vector candidate for the current video image 1b can be derived. As discussed above, the pre-estimation can be done with the aid of a resolution reduced current video image.

The determined motion vectors are projected to block positions of the current video image 1b, at 16. This is also visualized in FIG. 2b. The motion vectors 4 are projected by four blocks to the right to new block positions 3′. The projected motion vectors are visualized as projected motion vectors 4′ in FIG. 2b.

At 17, as also discussed above, update vector candidates are generated by multiplying some or each of the projected motion vectors, such as motion vectors 4′, with a random number.

At 18, a motion estimation for a current block, visualized exemplary as current block 5 in FIG. 2b, of the current video image 1b is performed on the basis of the projected motion vectors, such as motion vectors 4′, as discussed above, and on the basis of the general motion vector, the approximate motion vector candidate and/or the update motion vector candidate.

In FIG. 2b it is shown that for the current block 5, the projected motion vectors 4′ at the position of the current block 5 and at the projected block positions 3′, left, right, above and below the current block 5 are used for the motion estimation.

The method 10 is repeated until all current blocks of current video image 1b have been processed and, thus, until for each block 2b of current video image 1b a motion vector has been estimated. The estimated motion vectors are output and method 10 ends at 19.

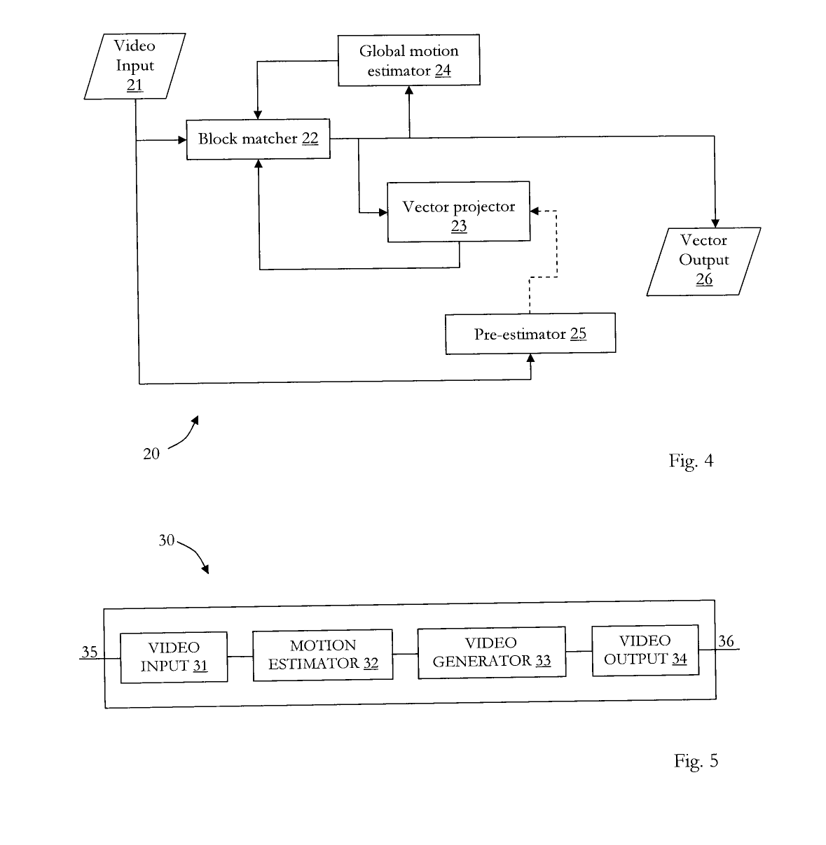

FIG. 4 illustrates an embodiment of an apparatus for estimating motion vectors for blocks of a current video image in a sequence of video images, each video image being divided into a plurality of blocks, such as discussed in connection with FIGS. 2a and 2b. Here, exemplary, the apparatus is a motion estimator 20, which is also configured to carry out method 10 as explained in connection with FIG. 3 and as explained above.

The motion estimator 20 has a video input 21 for receiving the sequence of video images. The video images are transferred to a block matcher 22 coupled to the video input 21. The block matcher 22 is configured to estimate motion vectors for blocks of the video images, as discussed above in detail.

A vector projector 23 is configured to project the determined motion vectors of blocks of a previous video image (such as motion vectors 4 in FIG. 2a), as received from coupled block matcher 22, to block positions (such as blocks 3′) of the current video image, thereby obtaining projected motion vectors (such as projected motion vectors 4′ in FIG. 2b).

The block matcher 22 is further configured to perform motion estimation for a current block of the current video image or all current blocks on the basis of the projected motion vectors, as discussed above.

For the reasons explained above, i.e. for cases where no or multiple projected motion vectors are available or where the convergence of the motion estimation should be faster, the motion estimator 20 has a global motion estimator 24 configured to estimate a global motion vector of the current video image, as discussed above. The global motion estimator 24 is coupled with the block matcher 22 in order to provide global motion vectors to the block matcher 22 and in order to receive the current and/or previous video image and/or estimated motion vectors of the previous video image.

The motion estimator 20 also has a pre-estimator 25 configured to estimate an approximate motion vector candidate, which is coupled to the video input 21 for receiving current/previous video images. The pre-estimator 25 is also coupled to the vector projector 23, for providing approximate motion vector candidates to the vector projector 23 and/or to the block matcher 22. As discussed, the block matcher 22 is further configured to perform the motion estimation for a current block additionally on the basis of the approximate motion vector.

As also discussed above, the block matcher is further configured to multiply the projected motion vectors with a random number, thereby obtaining update candidate vectors. Hence, the block matcher 22 can perform motion estimation on the basis of the projected motion vectors, global motion vector, approximate vector candidate, update vector candidate, dependent on the constraints discussed above.

The motion vectors estimated for each block of the current video image are output by a vector output 26, which is coupled to the block matcher.

The motion estimator 20 can be configured to perform multiple motion estimations for multiple current blocks of the current video image simultaneously. The motion estimator 20 can be implemented, for example, by a graphics processing unit (GPU), which is adapted to compute large amounts of data in parallel, since for each current block of a current video image the motion estimation can be performed independently, since the motion estimation is based on the estimated motion vectors of a previous video image.

FIG. 5 illustrates an electronic device 30 for generating a video image sequence. As discussed above, the electronic device 30 can be exemplary a graphic card for a personal computer or the like (see list of examples mentioned above), which is used for up-converting a received video image sequence scanned with a scan rate of e.g. 24 Hz to an output video image sequence having a scan rate higher than the input video image sequence (such as 100 Hz).

The electronic device has a video input 31 which receives over an input line 35 an input video image sequence scanned with a scan rate of e.g. 24 Hz. The electronic device has a motion estimator 32, such as motion estimator 20 discussed in connection with FIG. 4, which is coupled to the video input 31 and receives the video images. The motion estimator 20 outputs estimated motion vectors for each block of a current video image, as discussed above.

A video image sequence generator 33, coupled to the motion estimator 32, generates inter-images on the basis of the estimated motion vectors output by the motion estimator 32, as discussed above. The video image sequence generator 33 uses the inter-images for up-converting the input video image sequence by inserting inter-images between a previous and a subsequent image of the input video image sequence. Thereby, the video image sequence generator 33 generates an output video image sequence having a scan rate higher than the input video image sequence (e.g. 100 Hz) on the basis of the input video image sequence and the inter-images and outputs it to a video output 34. The video output 34 outputs the up-converted video image sequence on an output line 36 for, e.g. being displayed on a display.

Moreover, some embodiments pertain to a computer program comprising program code causing a computer to perform at least partially the method(s) discussed above in connection with FIG. 3.

Some embodiments also pertain to a non-transitory computer-readable recording medium that stores therein a computer program product, which, when executed by a processor, causes the method(s) discussed above in connection with FIG. 3 to be performed at least partially.

Note that the present technology can also be configured as described below.

(1) A method for estimating motion vectors for blocks of a current video image in a sequence of video images, each video image being divided into a plurality of blocks, the method comprising:
determining a motion vector for a block of a previous video image;
projecting the determined motion vector of the block of the previous video image to a block position of the current video image, thereby obtaining a projected motion vector; and
performing a motion estimation for a current block of the current video image on the basis of the projected motion vector, thereby obtaining a motion vector for the current block of the current video image.
   (2) The method of (1), wherein the motion estimation is performed on the basis of at least one of: projected motion vector at the block position of the current block and projected motion vector at a block position being adjacent to the current block.
   (3) The method of (1) or (2), wherein the motion estimation is performed on the basis of a set of candidate vectors including at least one projected motion vector at the block position of the current block and at least one projected motion vector at a block position being adjacent to the current block.
   (4) The method of anyone of (1) to (3), further comprising performing a global motion estimation for estimating a global motion vector of the current video image.
   (5) The method of (4), wherein the global motion estimation is based on a global motion model.
   (6) The method of (4) or (5), wherein the projection of the determined motion vector of the block of the previous video image to a block position of the current video image is performed on the basis of the global motion vector.
   (7) The method of anyone of (1) to (6), further comprising pre-estimating an approximate motion vector candidate and wherein the motion estimation for a current block is additionally performed on the basis of the approximate motion vector candidate.
   (8) The method of (7), wherein the pre-estimating includes reducing the size of the current video image.
   (9) The method of anyone of (1) to (8), further comprising obtaining an update candidate vector by manipulating the projected motion vector on the basis of a random number and performing the motion estimation additionally on the basis of the update candidate vector.
   (10) An apparatus for estimating motion vectors for blocks of a current video image in a sequence of video images, each video image being divided into a plurality of blocks, the apparatus comprising:
a block matcher configured to estimate motion vectors for blocks of the video images; and
a vector projector configured to project determined motion vectors of blocks of a previous video image to block positions of the current video image, thereby obtaining projected motion vectors; wherein the block matcher is further configured to perform a motion estimation for a current block of the current video image on the basis of at least one projected motion vector, thereby obtaining a motion vector for the current block of the current video image.
   (11) The apparatus of (10), wherein the block matcher is further configured to perform the motion estimation on the basis of at least one of: projected motion vector at the block position of the current block and projected motion vector at a block position being adjacent to the current block.
   (12) The apparatus of (10) or (11), wherein the block matcher is further configured to perform the motion estimation on the basis of a set of candidate vectors including at least one projected motion vector at the block position of the current block and at least one projected motion vector at a block position being adjacent to the current block.
   (13) The apparatus of anyone of (10) to (12), further comprising a global motion estimator configured to estimate a global motion vector of the current video image.
   (14) The apparatus of (13), wherein the global motion estimator is further configured to estimate the global motion vector on the basis of a global motion model.
   (15) The apparatus of (13) or (14), wherein the vector projector is further configured to project determined motion vectors of blocks of the previous video image to block positions of the current video image on the basis of the global motion vector.
   (16) The apparatus of anyone of (10) to (15), further comprising a pre-estimator configured to estimate an approximate motion vector candidate and wherein the block matcher is further configured to perform the motion estimation for a current block additionally on the basis of the approximate motion vector candidate.
   (17) The apparatus of (16), wherein the pre-estimator is further configured to reduce the size of the current video image.
   (18) The apparatus of anyone of (10) to (17), wherein the block matcher is further configured to generate an update candidate vector by manipulating the projected motion vector on the basis of a random number, and wherein the block matcher is further configured to perform the motion estimation additionally on the basis of the update candidate vector.
   (19) The apparatus of anyone of (10) to (18), further configured to perform multiple motion estimations for multiple current blocks of the current video image simultaneously.
   (20) An electronic device for generating a video image sequence, comprising:
a video input for receiving an input video image sequence;
the apparatus for estimating motion vectors of anyone of (10) to (19); and
a video image sequence generator configured to generate inter-images on the basis of the estimated motion vectors and to generate an output video image sequence on the basis of the input video image sequence and the inter-images.
   (21) A computer program comprising program code causing a computer to perform the method according to anyone of (1) to (9), when being carried out on a computer.
   (22) A non-transitory computer-readable recording medium that stores therein a computer program product, which, when executed by a processor, causes the method according to anyone of (1) to (9) to be performed.

The present application claims priority to European Patent Application 13 189 512.0, filed in the European Patent Office on 21 Oct. 2013, the entire contents of which being incorporated herein by reference.

1. A method for estimating motion vectors for blocks of a current video image in a sequence of video images, each video image being divided into a plurality of blocks, the method comprising:
determining a motion vector for a block of a previous video image;
projecting the determined motion vector of the block of the previous video image to a block position of the current video image, thereby obtaining a projected motion vector; and
performing a motion estimation for a current block of the current video image on the basis of the projected motion vector, thereby obtaining a motion vector for the current block of the current video image.

2. The method of claim 1, wherein the motion estimation is performed on the basis of at least one of: projected motion vector at the block position of the current block and projected motion vector at a block position being adjacent to the current block.

3. The method of claim 2, wherein the motion estimation is performed on the basis of a set of candidate vectors including at least one projected motion vector at the block position of the current block and at least one projected motion vector at a block position being adjacent to the current block.

4. The method of claim 1, further comprising performing a global motion estimation for estimating a global motion vector of the current video image.

5. The method of claim 4, wherein the global motion estimation is based on a global motion model.

6. The method of claim 4, wherein the projection of the determined motion vector of the block of the previous video image to a block position of the current video image is performed on the basis of the global motion vector.

7. The method of claim 1, further comprising pre-estimating an approximate motion vector candidate and wherein the motion estimation for a current block is additionally performed on the basis of the approximate motion vector candidate.

8. The method of claim 7, wherein the pre-estimating includes reducing the size of the current video image.

9. The method of claim 1, further comprising obtaining an update candidate vector by manipulating the projected motion vector on the basis of a random number and performing the motion estimation additionally on the basis of the update candidate vector.

10. An apparatus for estimating motion vectors for blocks of a current video image in a sequence of video images, each video image being divided into a plurality of blocks, the apparatus comprising:
a block matcher configured to estimate motion vectors for blocks of the video images; and
a vector projector configured to project determined motion vectors of blocks of a previous video image to block positions of the current video image, thereby obtaining projected motion vectors; wherein the block matcher is further configured to perform a motion estimation for a current block of the current video image on the basis of at least one projected motion vector, thereby obtaining a motion vector for the current block of the current video image.

11. The apparatus of claim 10, wherein the block matcher is further configured to perform the motion estimation on the basis of at least one of: projected motion vector at the block position of the current block and projected motion vector at a block position being adjacent to the current block.

12. The apparatus of claim 11, wherein the block matcher is further configured to perform the motion estimation on the basis of a set of candidate vectors including at least one projected motion vector at the block position of the current block and at least one projected motion vector at a block position being adjacent to the current block.

13. The apparatus of claim 10, further comprising a global motion estimator configured to estimate a global motion vector of the current video image.

14. The apparatus of claim 13, wherein the global motion estimator is further configured to estimate the global motion vector on the basis of a global motion model.

15. The apparatus of claim 13, wherein the vector projector is further configured to project determined motion vectors of blocks of the previous video image to block positions of the current video image on the basis of the global motion vector.

16. The apparatus of claim 10, further comprising a pre-estimator configured to estimate an approximate motion vector candidate and wherein the block matcher is further configured to perform the motion estimation for a current block additionally on the basis of the approximate motion vector candidate.

17. The apparatus of claim 16, wherein the pre-estimator is further configured to reduce the size of the current video image.

18. The apparatus of claim 10, wherein the block matcher is further configured to generate an update candidate vector by manipulating the projected motion vector on the basis of a random number, and wherein the block matcher is further configured to perform the motion estimation additionally on the basis of the update candidate vector.

19. The apparatus of claim 10, further configured to perform multiple motion estimations for multiple current blocks of the current video image simultaneously.
